(19) United States
(12) Patent Application Publication
(10) Pub. No.: US 2011/0295931 A1
(43) Pub. Date: Dec. 1, 2011

(54) METHODS, SYSTEMS, AND COMPUTER PROGRAM PRODUCTS FOR PROCESSING A COMBINED COMMAND RESPONSE

(76) Inventor: Robert Paul Morris, Raleigh, NC (US)

(21) Appl. No.: 12/788,381

(22) Filed: May 27, 2010

(51) Int. Cl. G06F 15/16

(52) U.S. Cl. 709/203

(57) ABSTRACT

Methods and systems are described for processing a combined command response. In one aspect, a first HTTP request identifying a first command and a second HTTP request identifying a second command are sent by a user agent node to a server node. A combined HTTP response is received. A determination is made that the combined HTTP response includes a first command response for the first command and a second command response for the second command.

In another aspect, a first HTTP request identifying a first command and a second HTTP request identifying a second command are received by a server node from a user agent node. A first command response for the first command and a second command response for the second command are generated. The first command response and the second command response are sent to the user agent node in a combined HTTP response.

### RELATED APPLICATIONS

This application is related to the following commonly owned U.S. Patent Applications, the entire disclosure of each being incorporated by reference herein: application Ser. No. ______, (Docket No 0103) filed on 2010 May 27, entitled “Methods, Systems, and Program Products for Processing an Attached Command Response”; and

Application Ser. No. ______, (Docket No 0131) filed on 2010 May 27, entitled “Methods, Systems, and Program Products for Preventing Processing of an HTTP Response”.

### BACKGROUND

The protocol of the Web, Hypertext Transfer Protocol (HTTP), is a request/response protocol. More particularly, for each HTTP request there is a single HTTP response, unless an error occurs preventing generation and/or return of the response to the requesting user agent. HTTP requests and HTTP responses are communicated over a network connection. Multiple pairs of HTTP request and HTTP response messages can be exchanged over a single connection. HTTP responses must be returned via the connection in the order that their corresponding HTTP requests were exchanged via the connection.

An HTTP request that takes a relatively long time to perform or process by a server holds up HTTP responses to any HTTP requests received afterwards. Depending on the implementation of a particular server, the long-running HTTP request can prevent the particular server from beginning to perform commands identified in any later sent HTTP requests.

HTTP is used by web browsers that interact with people. Delays in responding can be frustrating to people. This frustration may be costly to website providers as users sometimes resubmit requests wasting the resources of a service provider. Possibly worse, some users move on to another service provider or other activity.

The issues discussed above are exemplary issues associated with the current request-response model of the Web. Accordingly, there exists a need for methods, systems, and computer program products for processing a combined command response.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Methods and systems are described for processing a combined command response. In one aspect, the method includes sending, in a first HTTP request from a user agent node to a server node, first command information identifying a first command. The method further includes sending, in a second HTTP request to the server node, second command information identifying a second command. The method still further includes receiving, from the server node, a combined HTTP response. The method additionally includes determining, in response to sending the first command information and the second command information, that the combined HTTP response includes a first command response to the first command and a second command response to the second command.

Further, a system for processing a combined command response is described. The system includes an execution environment including an instruction-processing unit configured to process an instruction included in at least one of a request-out component, a response-in component, and a combined response component. The system includes the request-out component configured for sending, in a first HTTP request from a user agent node to a server node, first command information identifying a first command. The system further includes the request-out component configured for sending, in a second HTTP request to the server node, second command information identifying a second command. The system still further includes the response-in component configured for receiving, from the server node, a combined HTTP response. The system still also includes the combined response component configured for determining, in response to sending the first command information and the second command information, that the combined HTTP response includes a first command response to the first command and a second command response to the second command.

In another aspect, a method for processing a combined command response is described that includes receiving, in a first HTTP request from a user agent node, first command information identifying a first command. The method further includes receiving, in a second HTTP request from the user agent node, second command information identifying a second command. The method still further includes generating a first command response for the first command. The method also includes generating a second command response for the second command. The method additionally includes sending a combined HTTP response including the first command response, in response to identifying the first command, and including the second command response, in response to identifying the second command.

Still further, a system for processing a combined command response is described. The system includes an execution environment including an instruction-processing unit configured to process an instruction included in at least one of a request-in component, a first response generator component, a second response generator component, and a response-out component. The system includes the request-in component configured for receiving, in a first HTTP request from a user agent node, first command information identifying a first command. The system further includes the request-in component configured for receiving, in a second HTTP request from the user agent node, second command information identifying a second command. The system still further includes the first response generator component configured for generating a first command response for the first command. The system also includes the second response generator component configured for generating a second command response for the second command. The system additionally includes the response-out component configured for sending a combined HTTP response including the first command response, in response to identifying the first command, and including the second command response, in response to identifying the second command.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2a is a flow diagram illustrating a method for processing a combined command response according to an aspect of the subject matter described herein;

FIG. 2b is a flow diagram illustrating a method for processing a combined command response according to an aspect of the subject matter described herein;

FIG. 3a is a block diagram illustrating an arrangement of components for processing a combined command response according to another aspect of the subject matter described herein;

FIG. 3b is a block diagram illustrating an arrangement of components for processing a combined command response according to another aspect of the subject matter described herein;

FIG. 4 is a block diagram illustrating an arrangement of components for processing a combined command response according to another aspect of the subject matter described herein;

FIG. 5 is a block diagram illustrating an arrangement of components for processing a combined command response according to another aspect of the subject matter described herein;

FIG. 6 is a network diagram illustrating an exemplary system for processing a combined command response according to an aspect of the subject matter described herein;

FIG. 7 is a diagram illustrating a user interface presented via a display according to an aspect of the subject matter described herein;

FIG. 8 is a message flow diagram illustrating a message flow in a system for processing a combined command response according to an aspect of the subject matter described herein;

FIG. 9a illustrates an exemplary request message according to an aspect of the subject matter described herein;

FIG. 9b illustrates an exemplary request message according to an aspect of the subject matter described herein;

FIG. 9c illustrates an exemplary response message according to an aspect of the subject matter described herein;

FIG. 10a Illustrates an exemplary request message according to an aspect of the subject matter described herein;

FIG. 10b Illustrates an exemplary request message according to an aspect of the subject matter described herein; and

FIG. 10c illustrates an exemplary response message according to an aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art that one or more aspects of the disclosure may be practiced with a lesser degree of these specific details. In other instances, well-known structures and devices are shown in block diagram form in order to facilitate describing one or more aspects of the disclosure.

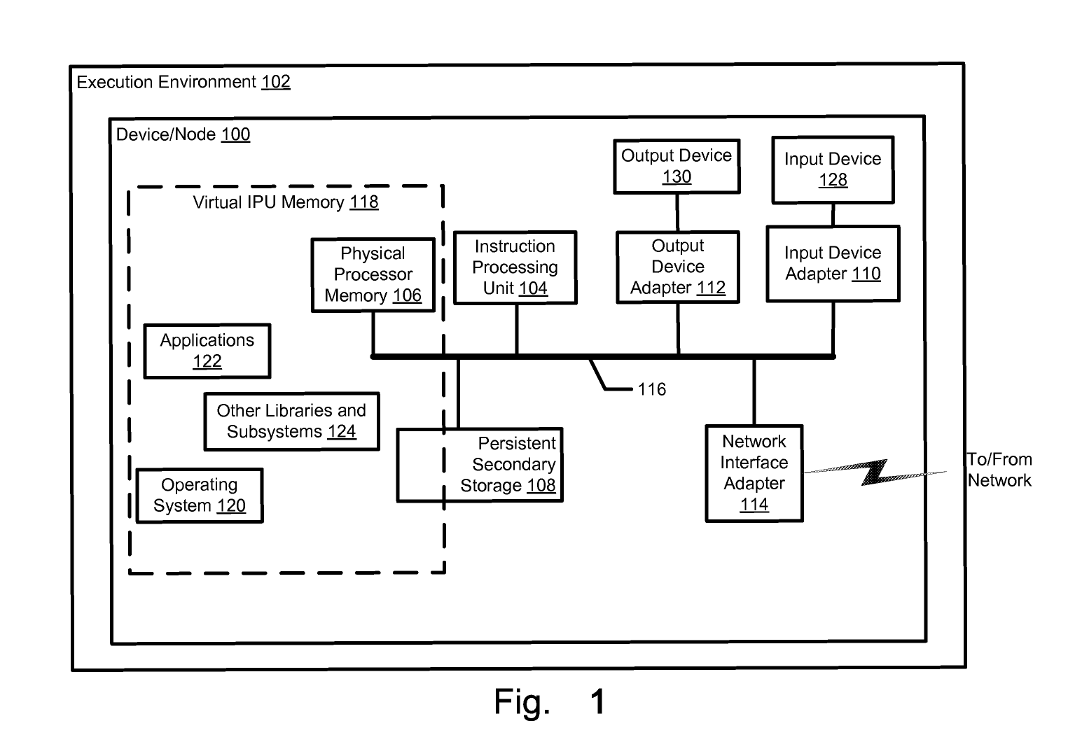

An exemplary device included in an execution environment that may be configured according to the subject matter is illustrated in FIG. 1. An execution environment includes an arrangement of hardware and, optionally, software that may be further configured to include an arrangement of components for performing a method of the subject matter described herein. An execution environment includes and/or is otherwise provided by one or more devices. An execution environment may include a virtual execution environment including software components operating in a host execution environment. Exemplary devices included in or otherwise providing suitable execution environments for configuring according to the subject matter include personal computers, notebook computers, tablet computers, servers, hand-held and other mobile devices, multiprocessor devices, distributed devices, consumer electronic devices, and/or other network-enabled devices. Those skilled in the art will understand that the components illustrated in FIG. 1 are exemplary and may vary by particular execution environment.

FIG. 1 illustrates hardware device 100 included in execution environment 102. FIG. 1 illustrates that execution environment 102 includes instruction-processing unit (IPU) 104, such as one or more microprocessors; physical processor memory 106 including storage locations identified by addresses in a physical memory address space of IPU 104; persistent secondary storage 108, such as one or more hard drives and/or flash storage media; input device adapter 110, such as a key or keypad hardware, a keyboard adapter, and/or a mouse adapter; output device adapter 112, such as a display or audio adapter for presenting information to a user; a network interface component, illustrated by network interface adapter 114, for communicating via a network such as a LAN and/or WAN; and a communication mechanism that couples elements 104-114, illustrated as bus 116. Elements 104-114 may be operatively coupled by various means. Bus 116 may comprise any type of bus architecture, including a memory bus, a peripheral bus, a local bus, and/or a switching fabric.

IPU 104 is an instruction execution machine, apparatus, or device. Exemplary IPUs include one or more microprocessors, digital signal processors (DSPs), graphics processing units, application-specific integrated circuits (ASICs), and/or field programmable gate arrays (FPGAs). In the description of the subject matter herein, the terms “IPU” and “processor” are used interchangeably. IPU 104 may access machine code instructions and data via one or more memory address spaces in addition to the physical memory address space. A memory address space includes addresses identifying locations in a processor memory. The addresses in a memory address space are included in defining a processor memory. IPU 104 may have more than one processor memory. Thus, IPU 104 may have more than one memory address space. IPU 104 may access a location in a processor memory by processing an address identifying the location. The processed address may be in an operand of a machine code instruction and/or may be identified in a register or other portion of IPU 104.

FIG. 1 illustrates virtual processor memory 118 spanning at least part of physical processor memory 106 and at least part of persistent secondary storage 108. Virtual memory addresses in a memory address space may be mapped to physical memory addresses identifying locations in physical processor memory 106. An address space for identifying locations in a virtual processor memory is referred to as a virtual memory address space; its addresses are referred to as virtual memory addresses; and its processor memory is known as a virtual processor memory or virtual memory. The term “processor memory” may refer to physical processor memory 106 and/or virtual processor memory 118 depending on the context in which the term is used.

Physical processor memory 106 may include various types of memory technologies. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), and/or RAMBUS DRAM (RDRAM). Physical processor memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include removable media. The drives and their associated computer readable storage media provide volatile and/or nonvolatile storage for computer readable instructions, data structures, program components, and other data for execution environment 102.

Execution environment 102 may include software components stored in persistent secondary storage 108, in remote storage accessible via a network, and/or in a processor memory. FIG. 1 illustrates execution environment 102 including operating system 120, one or more applications 122, and other program code and/or data components illustrated by other libraries and subsystems 124. In an aspect, some or all software components may be stored in locations accessed by IPU 104 in a shared memory address space shared by the software components. The software components accessed via the shared memory address space are stored in a shared processor memory defined by the shared memory address space. In another aspect, a first software component may be stored in one or more locations accessed by IPU 104 in a first address space and a second software component may be stored in one or more locations accessed by IPU 104 in a second address space. The first software component is stored in a first processor memory defined by the first address space and the second software component is stored in a second processor memory defined by the second address space.

Software components typically include instructions executed by IPU 104 in a context referred to as a “process”. A process may include one or more “threads”. A thread includes a sequence of instructions executed by IPU 104 in a thread context. The terms “thread” and “process” may be used interchangeably herein when a process includes only one thread.

Execution environment 102 may receive user-provided information via one or more input devices illustrated by input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding communication interfaces such as a serial port, a parallel port, and/or a universal serial bus (USB) port. Input device adapter 110 receives input and provides a representation to bus 116 to be received by IPU 104, physical processor memory 106, and/or other components included in execution environment 102.

Output device 130 in FIG. 1 exemplifies one or more output devices that may be included in and/or may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion producing devices, and other output devices producing sensory information detectable by a user.

A device included in or otherwise providing an execution environment may operate in a networked environment communicating with one or more devices via one or more network interface components. The terms “communication interface component” and “network interface component” are used interchangeably. FIG. 1 illustrates network interface adapter (NIA) 114 as a network interface component included in execution environment 102 to operatively couple device 100 to a network. A network interface component includes a network interface hardware (NIH) component and optionally a software component. The terms “network node” and “node” in this document both refer to a device having a network interface component for operatively coupling the device to a network. The terms “device” and “node” as used herein refer to one or more devices and nodes, respectively, providing and/or otherwise included in an execution environment unless clearly indicated otherwise.

Exemplary network interface components include network interface controller components, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., a cellular, PCS, CDMA, and/or GSM network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The Hypertext Transfer Protocol (HTTP) is specified in “Request for Comments” (RFC) document RFC 2616 by R. Fielding, et al., titled “Hypertext Transfer Protocol—HTTP/1.1” (June 1999). Terms from RFC 2616 are defined below as used herein and are used in describing the subject matter in this document.

An “HTTP request” as used herein is defined in section 5 of RFC 2616 along with adaptations and/or extensions described below. An “HTTP response” as used herein is defined in section 6 of RFC 2616 along with adaptations and/or extensions described below. A “resource” is a data object or service that can be identified by a universal resource identifier (URI). An “HTTP entity” is information transferred as the payload of an HTTP request or an HTTP response. The term “HTTP entity” as used herein is defined as the term “entity” is defined in RFC 2616. An HTTP entity includes of meta-information in the form of entity-header fields and content in the form of an entity-body. An “HTTP representation” is an HTTP entity that is subject to content negotiation. The term “HTTP representation” is used herein as the term “representation” is used and defined in RFC 2616.

The terms “user agent” and “server” refer to roles played by one or more components and/or devices operating in an execution environment, and/or systems in an HTTP communication. A “user agent” initiates and/or sends a command in an HTTP request. A “server” accepts a command identified in an HTTP request in order to process the command. The terms “server”, “service”, and “service provider” are used interchangeably herein. Processing a command includes performing and/or otherwise providing for performing the command. The performing of the command may be successful or unsuccessful. As defined and described herein a server may send information in an HTTP response to a user agent in response to receiving a command from the user agent in an HTTP request.

A command identified in an HTTP request may be processed by a service provider. For example, a service provider may retrieve and/or generate a resource in processing a command. As used herein, a “command response” is a result produced in processing a command, from a user agent, identified in an HTTP request. The command response is produced to return to the user agent. A command response is returned in an HTTP response as specified in RFC 2616 and as further described herein according to the subject matter. According to the subject matter described herein, a command response may be returned in one or more HTTP responses.

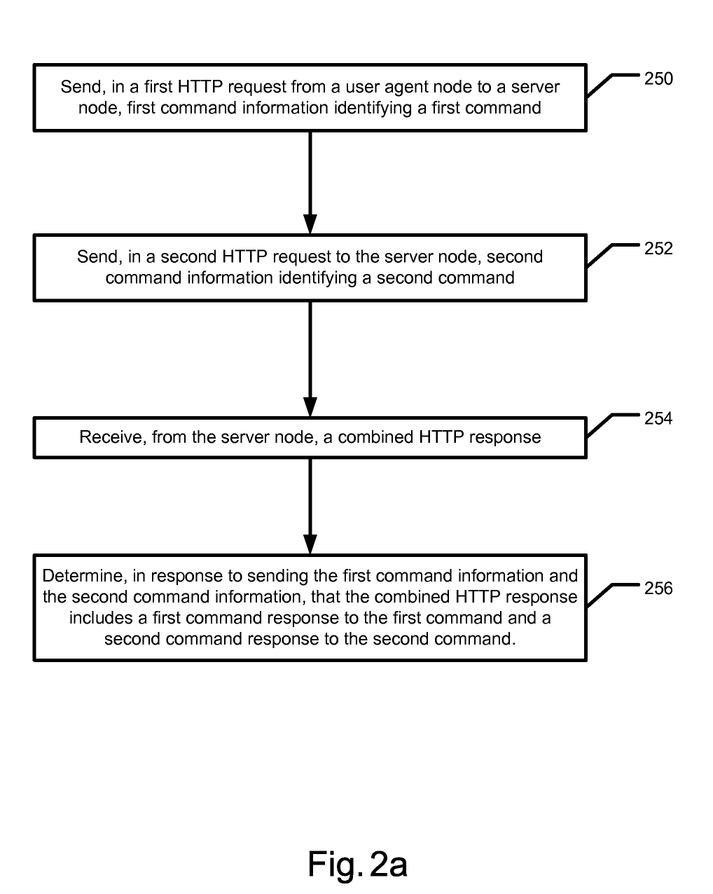

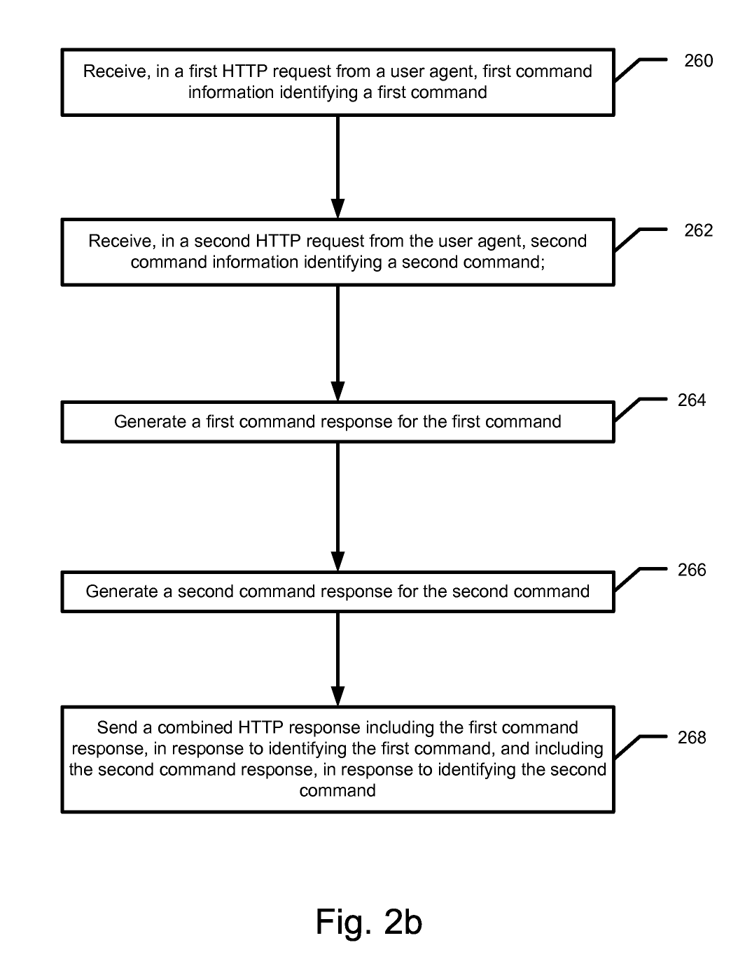

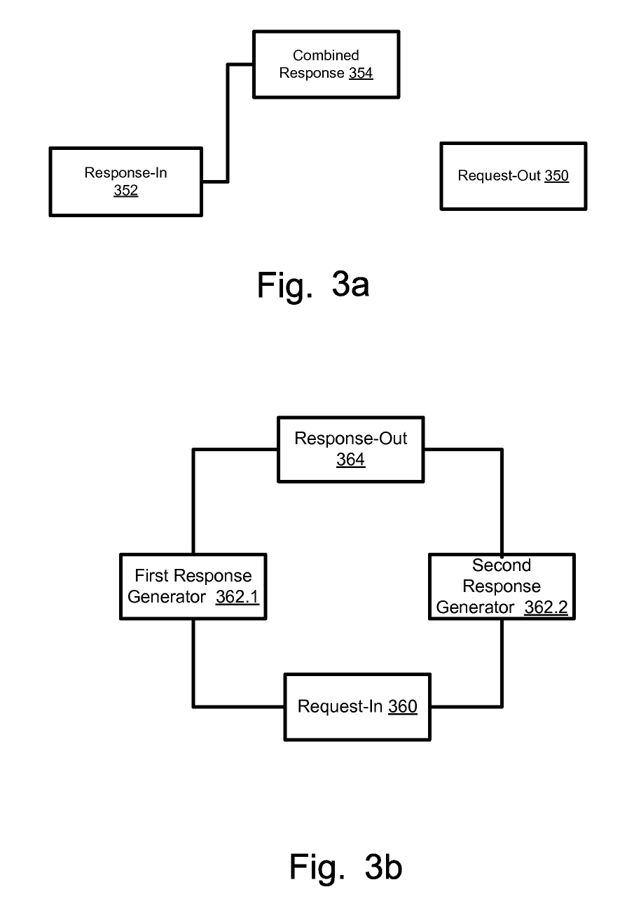

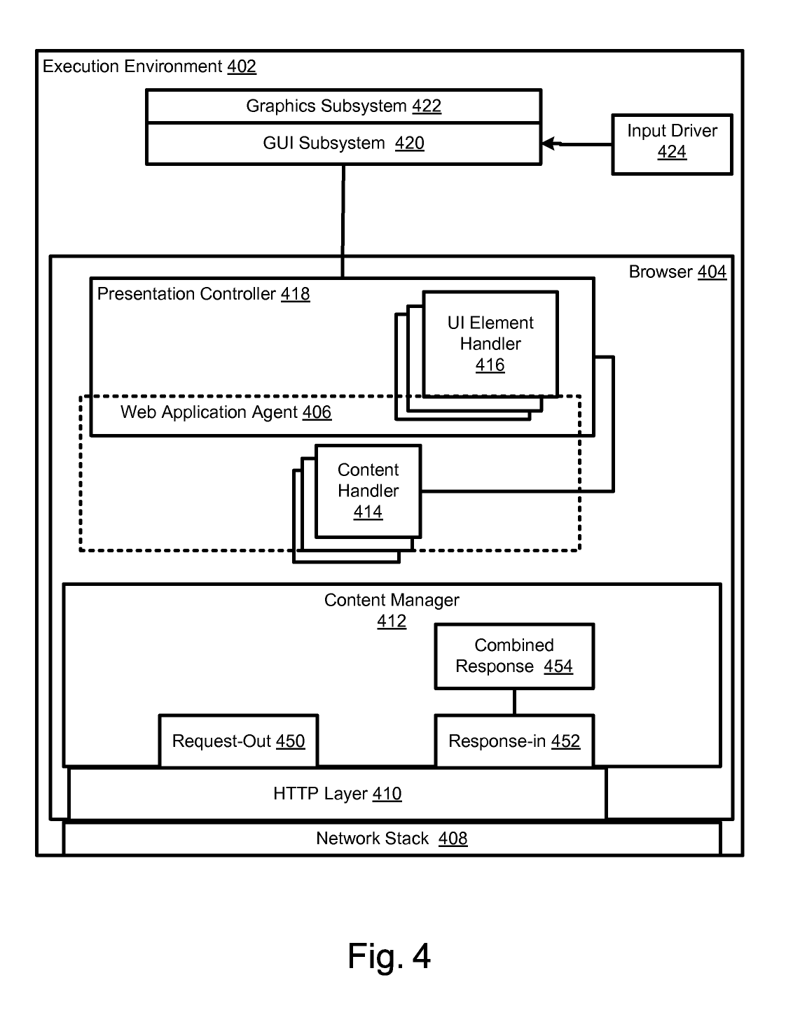

The block diagram in FIG. 3a illustrates an exemplary system for processing a combined command response according to the method illustrated in FIG. 2a. A system for performing the method illustrated in FIG. 2a includes an execution environment, including an instruction-processing unit, configured to process an instruction included in at least one of a request-out component 350, a response-in component 352, and a combined response component 354 illustrated in FIG. 3a. Some or all of the exemplary components illustrated in FIG. 3a may be adapted for performing the method illustrated in FIG. 2a in a number of execution environments. FIG. 4 is a block diagram illustrating the components of FIG. 3a and/or analogs of the components of FIG. 3a adapted for operation in execution environment 402 including or otherwise provided by one or more nodes.

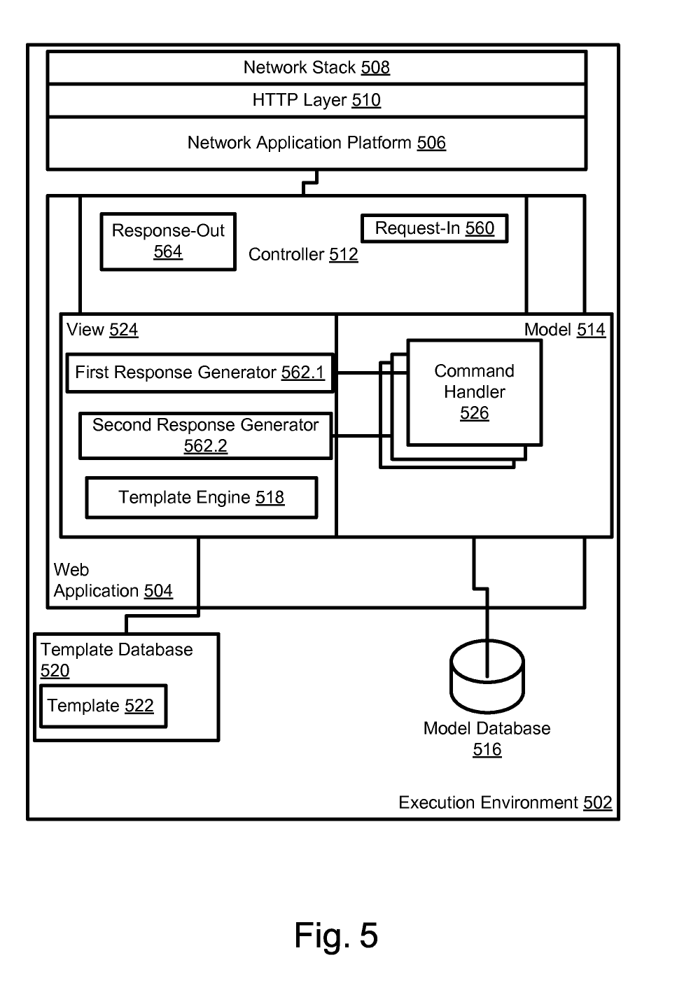

The block diagram in FIG. 3b illustrates an exemplary system for processing a combined command response according to the method illustrated in FIG. 2b. A system for performing the method illustrated in FIG. 2b includes an execution environment, including an instruction-processing unit, configured to process an instruction in at least one of a request-in component 360, a first response generator component 362.1, a second response generator component 362.2, and a response-out component 364 illustrated in FIG. 3b. Some or all of the exemplary components illustrated in FIG. 3b may be adapted for performing the method illustrated in FIG. 2b in a number of execution environments. FIG. 5 is a block diagram illustrating the components of FIG. 3b and/or analogs of the components of FIG. 3b adapted for operation in execution environment 502 including or otherwise provided by one or more nodes.

FIG. 1 illustrates components of an exemplary device that may at least partially provide and/or otherwise be included in an execution environment. The components illustrated in FIG. 4 and FIG. 5 may be included in or otherwise combined with the components of FIG. 1 to create a variety of arrangements of components according to the subject matter described herein.

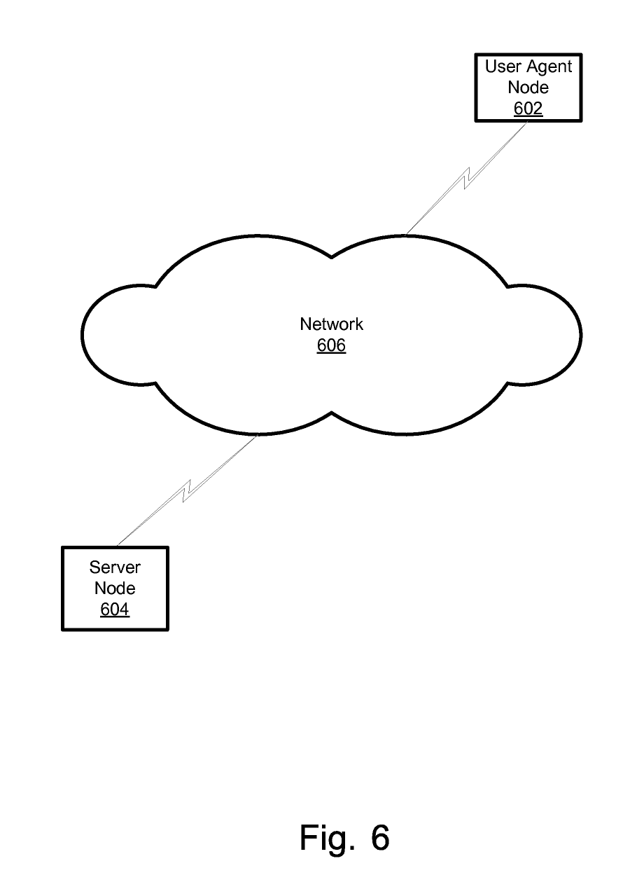

FIG. 6 illustrates user agent node 602 and server node 604 as exemplary devices included in and/or otherwise adapted for providing execution environment 402 and execution environment 502, respectively. As illustrated in FIG. 6, user agent node 602 and server node 604 are operatively coupled to network 606 via respective network interface components enabling user agent node 602 and server node 604 to communicate.

FIG. 4 illustrates execution environment 402 hosting a web browsing application illustrated as browser 404. It is common in HTTP communications for a browser and/or a web application agent operating in a browser to operate as user agents. FIG. 4 illustrates browser 404 including an adaptation of the arrangement of components in FIG. 3a. Web application agent 406 is illustrated operating in browser 404 and may be received from a remote application provider, such as web application 504 in FIG. 5. Browser 404 and execution environment 402 may provide at least part of an execution environment for web application agent 406. Browser 404, web application agent 406, HTTP layer 410, and/or user agent node 602 may operate in the role of user agent and/or may include a component operating as a user agent. FIG. 5 illustrates execution environment 502 hosting web application 504, typically operating in the role of a server in an HTTP communication. FIG. 5 illustrates an adaptation of the arrangement of components in FIG. 3b operating in web application 504.

As stated, the various adaptations of the arrangements in FIG. 3a and in FIG. 3b are not exhaustive. For example, those skilled in the art will see based on the description herein that arrangements of components for performing the methods illustrated in FIG. 2a and FIG. 2b may be distributed across more than one node and/or execution environment. For example, such an arrangement may operate at least partially in browser 404 in FIG. 4 and at least partially in execution environment 502 in FIG. 5.

FIG. 4 illustrates network stack 408 configured for sending and receiving messages over network 606 in FIG. 6, such as the Internet, via a network interface component of user agent node 602. FIG. 5 illustrates a network application platform 506 providing services to one or more web applications. FIG. 5 also illustrates network application platform 506 configured for interoperating with network stack 508. Network stack 408 and network stack 508 may support the same protocol suite, such as TCP/IP, or may communicate via a network gateway or other protocol translation device and/or service. Browser 404 in FIG. 4 and network application platform 506 in FIG. 5 may interoperate via their respective network stacks. Browser 404 and web application 504 may communicate via one or more application layer protocols. FIG. 4 illustrates HTTP layer 410 exemplifying an application layer protocol. FIG. 5 illustrates a compatible HTTP protocol layer as HTTP layer 510.

Browser 404, in FIG. 4, may receive some or all of web application agent 406 in one more messages sent from web application 504, in FIG. 5, via network application platform 506; and network stacks, network interface components, and optionally HTTP layers in the respective execution environments. In FIG. 4, browser 404 includes content manager component 412. Content manager component 412 may interoperate with HTTP layer component 410 and/or network stack 408 to receive the message or messages including some or all of web application agent 406.

Web application agent 406 may include a web page or other data representation for presenting a user interface for web application 504. The web page may include and/or reference data represented in one or more formats including hypertext markup language (HTML) and/or other markup languages, ECMAScript or other scripting languages, byte code, image data, audio data, and/or machine code to name just a few valid data representations depending on the capabilities of a receiving user agent node.

In response to an HTTP request including a command received from browser 404, controller component 512, in FIG. 5, may invoke model subsystem 514 to perform command specific processing. Model subsystem 514 may include any number of command processors, illustrated as command handler components 526, for dynamically generating data and/or retrieving data from model database 516 based on the command. Controller component 512 may further invoke one or more response generator components 562 for generating a command response to the received command. The one or more response generator components 562 may invoke template engine component 518 to identify one or more templates and/or other static data to combine with data received from command handler component(s) 526 generated in processing the command. FIG. 5 illustrates template database 520 including an exemplary template 522. The one or more response generator component(s) 562 in view subsystem 524 may interoperate with response-out component 564 in controller component 512 to return a command response generated from processing a command. The command response may be returned in one or more data formats suitable for a user agent, such as browser 404. Response-out component 564 may receive command response data from one or more response generator components 562 as one or more HTTP entities, and/or one or more HTTP representations. Alternatively or additionally, response-out component 564 may transform data from one or more response generator component(s) 562 into one or more HTTP entities and/or HTTP representations. Response-out component 564 may send the one or more HTTP entities in an HTTP response, in response to the HTTP request received from browser 404. Some or all of web application agent 406 may be sent to browser 404 via network application platform 506 in the manner described.

One or more HTTP responses including one or more representations of some or all of web application agent 406 may be received by content manager component 412 via HTTP layer 410 and network stack 408. In FIG. 4, browser 404 includes one or more content handler components 414 to process received HTTP representations according to their data types, typically identified by MIME-type identifiers. Exemplary content handler components 414 include a text/html content handler component for processing HTML representations; an application/xmpp-xml content handler component for processing XMPP streams including presence tuples, instant messages, and publish-subscribe data as defined by various XMPP specifications; one or more video content handler components for processing video representations of various types; and still image data content handler components for processing various image data representations. Content handler component(s) 414 process received HTTP representations and may provide data from the HTTP representations to one or more user interface element handler components 416.

User interface element handler components 416 are illustrated in presentation controller component 418 in FIG. 4. Presentation controller component 418 may manage visual, audio, and other types of output for its including application as well as receive and route detected user and other inputs to components and extensions of its including application, browser 404. With respect to FIG. 4, a user interface element handler component 416 may be adapted to operate at least partially in a content handler component 414 such as a text/html content handler component and/or a script content handler component. Additionally or alternatively, a user interface element handler component in execution environment 402 may operate in web application agent 406 and/or other extension of its including application, such as a plug-in providing a virtual machine for script and/or byte code.

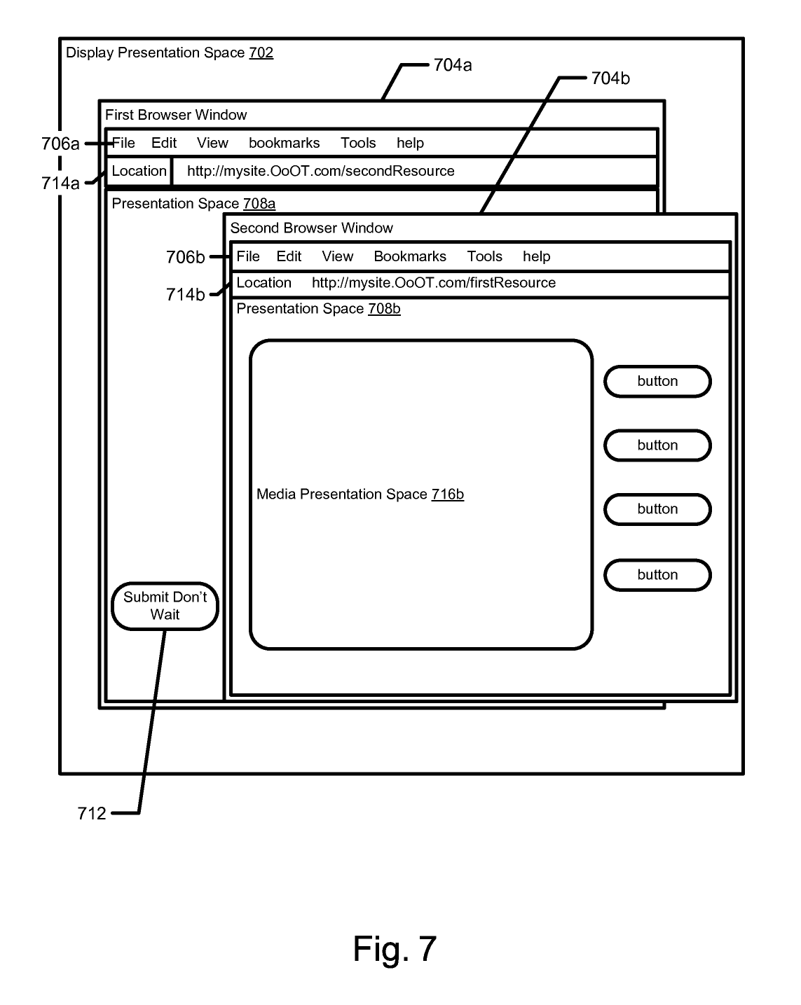

FIG. 7 illustrates a presentation space 702 of a display device, such as output device 130 in FIG. 1. Presentation space 702 includes first browser window 704a of browser 404, web application agent 406, and/or web application 504. FIG. 7 is used to illustrate various exemplary visual components of one or more of browser 404, web application agent 406, and web application 504.

The components of a user interface are generically referred to herein as user interface elements. More specifically, visual components of a user interface are referred to herein as visual interface elements. A visual interface element may be a visual component of a graphical user interface (GUI). Exemplary visual interface elements include windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes and radio buttons. An application interface may include one or more of the elements listed. Those skilled in the art will understand that this list is not exhaustive. The terms “visual representation”, “visual component”, and “visual interface element” are used interchangeably in this document. Other types of user interface elements include audio output components referred to as audio interface elements, tactile output components referred to as tactile interface elements, and the like.

A “user interface (UI) element handler” component, as the term is used in this document, includes a component configured to send information representing a program entity for presenting a user detectable representation of the program entity by an output device, such as a display. A “program entity” is an object included in and/or otherwise processed by an application or executable program component. The user detectable representation is presented based on the sent information. The sent information is referred to herein as “presentation information”. Presentation information may include data in one or more formats. Exemplary formats include image formats such as JPEG, video formats such as MP4, markup language data such as HTML and other XML-based markup, and/or instructions such as those defined by various script languages, byte code, and/or machine code. For example, a web page received by a browser from a remote application provider may include HTML ECMAScript, and/or byte code for presenting one or more user interface elements included in a user interface of the remote application. Components configured to send information representing one or more program entities for presenting particular types of output by particular types of output devices include visual interface elements, audio interface element handler components, tactile interface element handler components, and the like.

A representation of a program entity may be represented and/or otherwise maintained in a presentation space. As used in this document, the term “presentation space” refers to a storage region allocated and/or otherwise provided for storing presentation information, which may include audio, visual, tactile, and/or other sensory data for presentation by and/or on an output device. For example, a buffer for storing an image and/or text string may be a presentation space. A presentation space may be physically and/or logically contiguous or non-contiguous. A presentation space may have a virtual as well as a physical representation. A presentation space may include a storage location in processor memory, secondary storage, a memory of an output device adapter device, and/or a storage medium of an output device. A screen of a display, for example, is a presentation space.

As used herein, the term “program” or “executable” refers to any data representation that may be translated into a set of machine code instructions and optionally associated program data. Thus, a program or executable may include an application, a shared or non-shared library, and a system command. Program representations other than machine code include object code, byte code, and source code. Object code includes a set of instructions and/or data elements that either are prepared for linking prior to loading or are loaded into an execution environment. When in an execution environment, object code may include references resolved by a linker and/or may include one or more unresolved references. The context in which this term is used will make clear that state of the object code when it is relevant. This definition can include machine code and virtual machine code, such as Java™ byte code.

As used herein, an “addressable entity” is a portion of a program specifiable in a source code language, which is addressable within a compatible execution environment. Examples of addressable entities include variables, constants, functions, subroutines, methods, classes, anonymous scoped instruction sets, and labeled instructions. Strictly speaking, the addressable entity contains a value or an instruction, but it is not the value or the instruction. In some places, this document will use “addressable entity” in a manner that refers to the content or value of an addressable entity. In these cases, the context will clearly indicate the intended meaning.

Addressable entities may have a number of corresponding representations. These representations include source code, object code, and any intermediate formats used by an interpreter, compiler, linker, loader, or analogous tool. Thus, terms such as “addressable source code entity” may be used in cases where the format is relevant and may be unclear from the context.

Returning to FIG. 7, first browser window 704a and second browser window 704b collectively and generically are referred to as browser window(s) 704. Browser windows 704 illustrate a number of visual user interface elements commonly found in applications. Browser windows 704 include respective menu bars 706 with menu controls for receiving user input to identify commands to perform. Browser windows 704 also include respective user interface elements providing respective presentation spaces 708 for presenting content including other visual components.

Various user interface elements of browser 404, web application agent 406, and/or web application 504 described above may be presented by one or more user interface element handler components 416 and/or response generator components 562. User interface element handler component(s) 416 in FIG. 4 may send presentation information representing a visual interface element(s), such as menu bar 706 illustrated in FIG. 7, to GUI subsystem 420. GUI subsystem 420 may instruct graphics subsystem 422 to draw the visual interface element(s) in a region of display presentation space 702 in FIG. 7, based on the presentation information.

Input may be received via input driver 424 in FIG. 4. For example, a user may move a mouse to move a pointer presented in display presentation space 702 over an operation identifier in menu bar 706. The user may provide an input detected by the mouse. The detected input may be received by GUI subsystem 420 via input driver 424 as an operation or command indicator based on the association of the shared location of the pointer and the operation identifier in display presentation space 702.

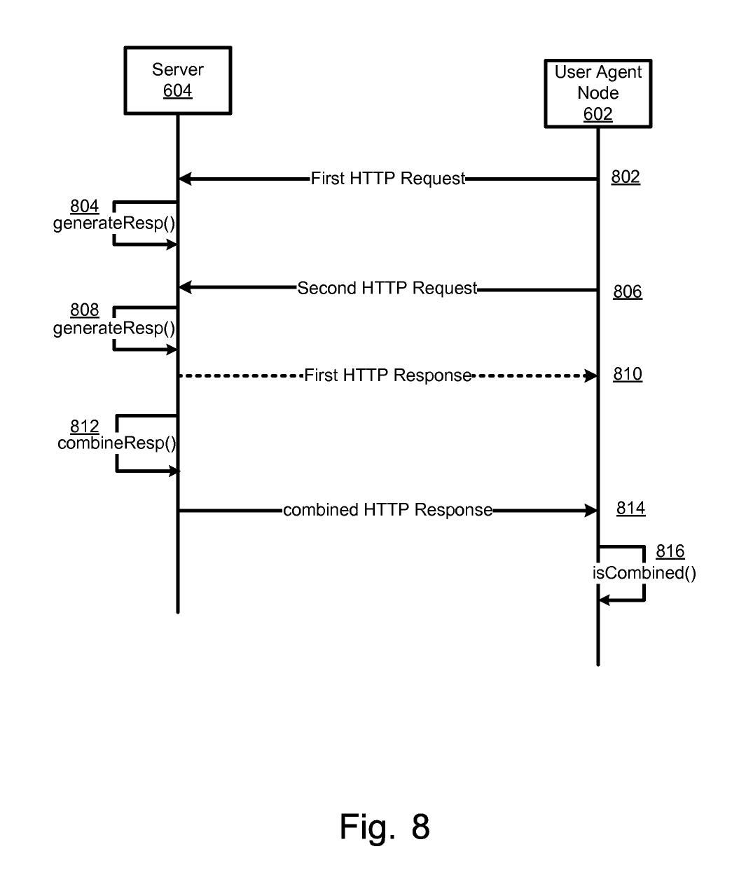

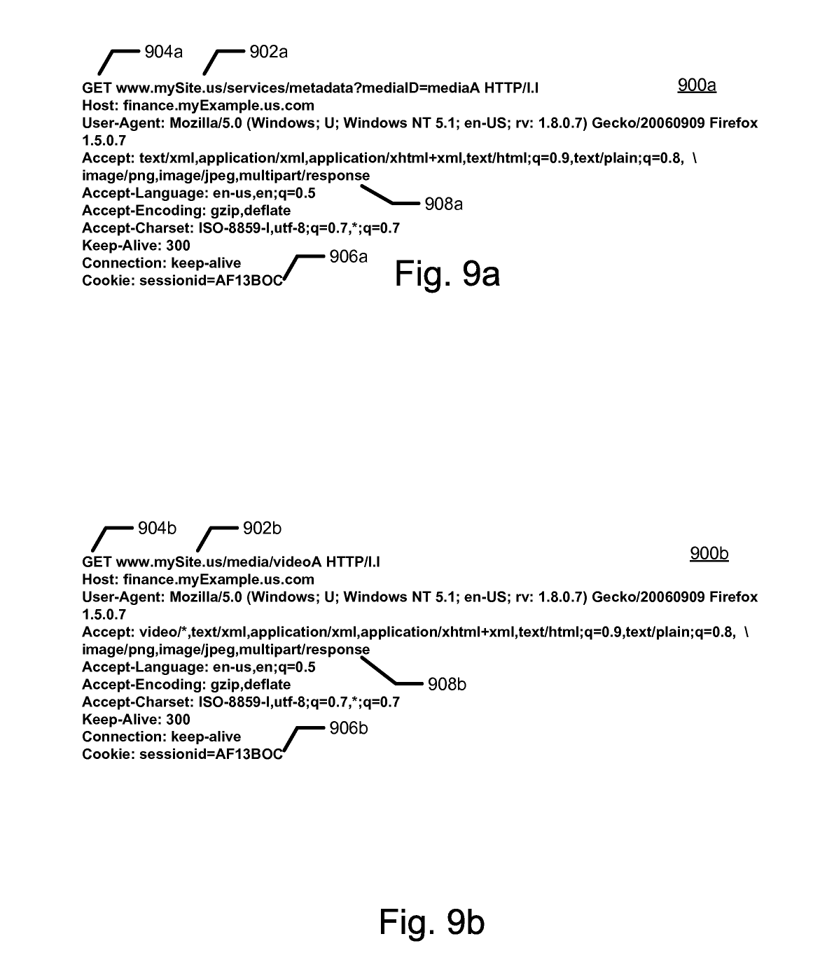

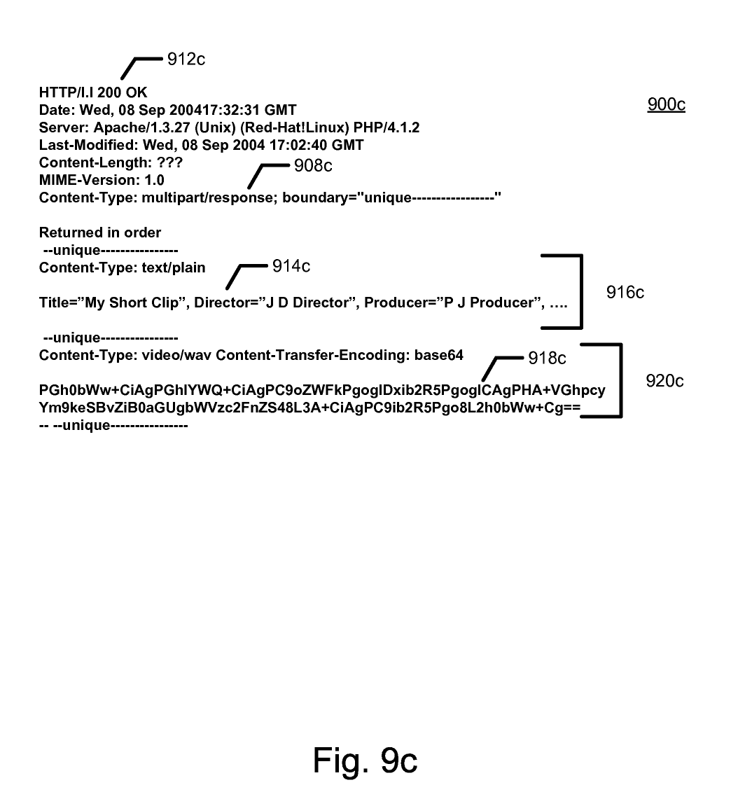

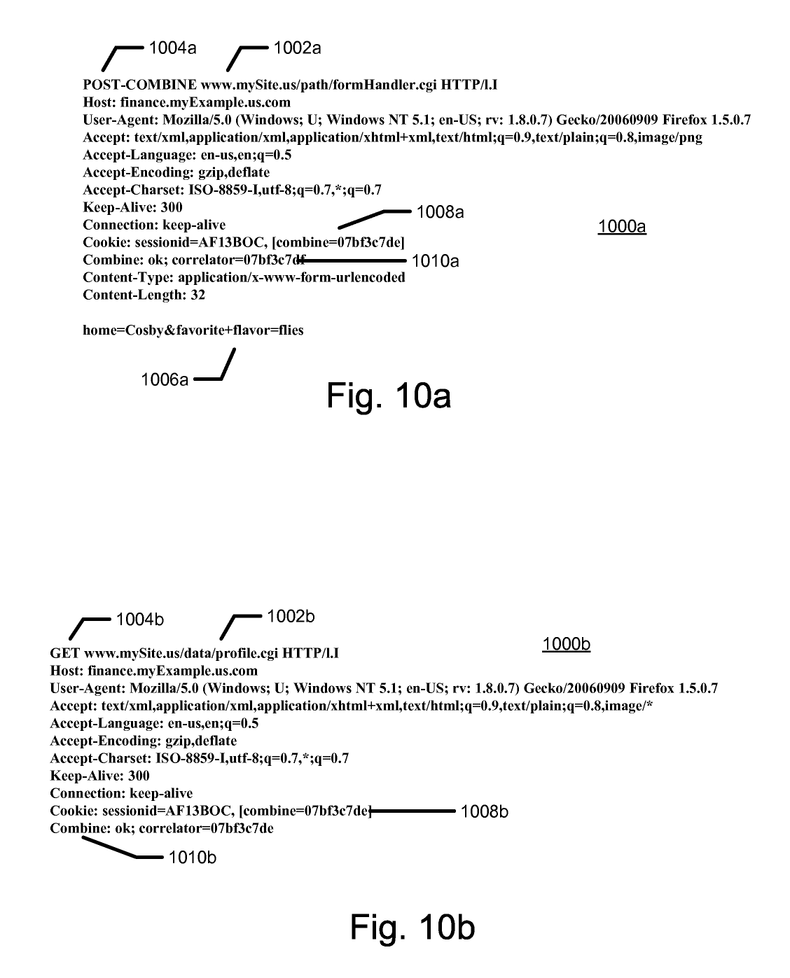

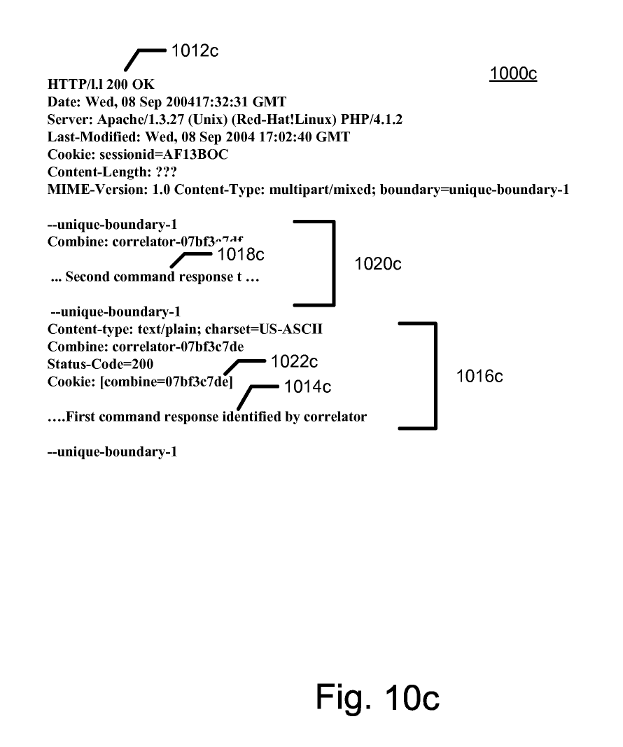

FIG. 8 is a message flow diagram illustrating an exemplary exchange of messages between and within user agent node 602 and server node 604 according to the subject matter described herein. FIG. 8 illustrates user agent node 602 in the role of a user agent sending a first command identified in a first HTTP request message 802 received by server node 604. The first HTTP request exchanged in first HTTP request message 802 is “combinable” as defined and described below. First HTTP request 900a in FIG. 9 and first HTTP request 1000a in FIG. 10 illustrate exemplary HTTP requests, which may be transmitted in first HTTP request message 802. A web browser, a web server, a web application, a web application platform, and a proxy server may operate as user agents and/or servers.

A “combinable command” is a command, sent in an HTTP request from by a user agent node to a server node, having a command response that may be transmitted, by the server node to the user agent node, in an HTTP response with another command response for another command. The command response of a combinable command is referred to herein as a “combinable command response”. An HTTP response that includes multiple combinable command responses is referred to herein as a “combined HTTP response”. When included in a combined HTTP response, a command response is referred to herein as a “combined command response”. A combined HTTP response may include a status code for the combined HTTP response referred to herein as a “combined status code”. A combined HTTP response may include zero or more command specific status codes associated with particular combined command responses included in the combined HTTP response.

Note that a combined HTTP response differs in some aspects from an attached HTTP response as defined and described in application Ser. No. ______, (Docket No 0103) filed on 2010 May 27, entitled “Methods, Systems, and Program Products for Processing an Attached Command Response”. An attached HTTP response is an HTTP response for a particular HTTP request that includes some or all of a command response for a command identified in another HTTP request. The other HTTP request may have its own HTTP response that when sent includes at most a portion of the command response for the command identified in the other HTTP request.

In FIG. 2a, block 250 illustrates that the method includes sending, in a first HTTP request from a user agent node to a server node, first command information identifying a first command. Accordingly, a system for processing a combined command response includes means for sending, in a first HTTP request from a user agent node to a server node, first command information identifying a first command. For example, as illustrated in FIG. 3a, request-out component 350 is configured for sending, in a first HTTP request from a user agent node to a server node, first command information identifying a first command.

FIG. 8 also illustrates user agent node 602 in the role of a user agent sending a second command identified in a second HTTP request message 806 received by server node 604. The second HTTP request exchanged in second HTTP request message 806 is “combinable” as defined and described below. Second HTTP request 900b in FIG. 9 and second HTTP request 1000b in FIG. 10 illustrate exemplary HTTP requests, which may be transmitted in second HTTP request message 806.

Returning to FIG. 2a, block 252 illustrates that the method further includes sending, in a second HTTP request to the server node, second command information identifying a second command. Accordingly, a system for processing a combined command response includes means for sending, in a second HTTP request to the server node, second command information identifying a second command. For example, as illustrated in FIG. 3a, request-out component 350 is configured for sending, in a second HTTP request to the server node, second command information identifying a second command. FIG. 4 illustrates request-out component 450 as an adaptation of and/or analog of request-out component 350 in FIG. 3a. One or more request-out components 450 operate in execution environment 402.

Request-out component 450 in FIG. 4 may send an HTTP request in various contexts. For example, browser 404 may send an HTTP request in response to a detected user input, in response to execution of an instruction received in an HTTP response, and in response to processing of a markup language element received in an HTTP response.

FIG. 4 illustrates that a user input may be received by presentation controller component 418 and/or a UI element handler component 416. The user input may correspond to a link in a web page such as a link associated with button UI element 712 illustrated in FIG. 7, an item in a bookmarks menu as illustrated in menu bars 706, and/or a history list (not shown). Alternatively or additionally, a URI may be received by presentation controller component 418 and/or a UI element handler component 416 via a keypad (physical or virtual) providing input for location bar 714. In another example, a web page may include a reference to a media representation for presenting in media presentation space 716b in a web page presented in presentation space 708b. A content handler component 414 processing the web page may detect a URI included in the reference. A resource such as the media representation may be retrieved by a script content handler component 414 interpreting a script included in web application agent 406, a media player plug-in, and/or other browser 404 extension in and/or otherwise interoperating with web application agent 406.

As described above and illustrated in FIG. 9a, FIG. 9b, and FIG. 10a, a command, such as the first command and/or the second command, identified in an HTTP request may be identified by command information including and/or otherwise based on an HTTP method token, a URI, an HTTP request line, an HTTP general header, an HTTP request header, and/or an HTTP entity that may be and/or may include an HTTP representation.

FIG. 9a, FIG. 9b, and FIG. 9c illustrate various exemplary HTTP messages included in an HTTP communication between browser 404 operating in user agent node 602 and web application 504 operating in server node 604. FIG. 9a illustrates first HTTP request 900a including first command information identifying a first command. First HTTP request 900a may be communicated in first HTTP message 802 in FIG. 8. Command information in first HTTP request 900a may include first URI 902a, illustrated as www.mySite.us/services/medata?mediaID=mediaA, identifying a metadata service for retrieving metadata for an identified media item. The media item is identified, in FIG. 9a, in first URI 902a by query parameter “mediaID” having a value of “mediaA”. The first command information in first HTTP request 900a may also include HTTP method token 904a illustrated as “GET”. Additional data included in the first command information may be included in an HTTP header. For example, cookie header 906a identifies a session identifier illustrated by a “sessionid” cookie. A server node may identify a command or an aspect of a command based on a value of a cookie and/or other HTTP header information. Server node 604 may be identified by a host portion of first URI 902a, “www.mySite.us”. First HTTP request 900a illustrates that command information may include information in one or more of first URI 902a, HTTP method token 904a, and cookie header 906a.

FIG. 9b illustrates second HTTP request 900b including second command information identifying a second command. Second HTTP request 900b may be communicated in second HTTP request message 806 in FIG. 8. The second command information in second HTTP request 900b may include second URI 902b, illustrated as www.mySite.us/services/media/videoA, identifying a media streaming service for streaming a media container identified in second URI 902b. As with the command information in first HTTP request 900a, second command information in second HTTP request 900b may include HTTP method token 904b and/or cookie header 906b. The value of “sessionid” cookie in cookie header 906b identifies a session identifier associating the first HTTP request 900a and the second HTTP request 900b. A host portion of second URI 902b, www.mySite.us, again identifies server node 604. Second HTTP request 900b illustrates that the second command information may include and/or otherwise may be based on one or more of second URI 902b, HTTP method token 904b, and cookie header 906b.

FIG. 10a, FIG. 10b, and FIG. 10c illustrate another set of exemplary HTTP messages included in an HTTP communication between browser 404 operating in user agent node 602 and web application 504 operating in server node 604. FIG. 10a illustrates first HTTP request 1000a. First HTTP request 1000a includes first URI 1002a, illustrated as www.mySite.us/path/formHandler.cgi, identifying a service for processing a form. First HTTP request 1000a also includes HTTP method token 1004a illustrated as “POST-COMBINE”. First command information may include form input 1006a. Form input 1006a is illustrated as an HTTP representation encoded according to MIME type “application/x-www-form-urlencoded”. Server node 604 may be identified by a host portion of first URI 1002a, www.mySite.us. Command information identifying the first command in first HTTP request 1000a may include information in one or more of first URI 1002a, HTTP method token 1004a, and an HTTP entity including HTTP representation 1006a.

FIG. 10b illustrates second HTTP request 1000b. Second HTTP request 1000b includes second URI 1002b illustrated as www.mySite.us/data/profile.cgi identifying a service for retrieving profile data for a user associated with a session identified in combine cookie 1008b. Some of the retrieved data may be data submitted and/or otherwise affected by data included in first HTTP request 1000a. Second HTTP request 1000b includes HTTP method token 1004b illustrated as “GET”. Server node 604 is identified by a host portion of second URI 1002b, www.mySite.us. Command information identifying the second command in second HTTP request 1000b may include information in one or more of second URI 1002b, HTTP method token 1004b, and combine cookie 1008b.

In the examples in the previous paragraphs, various user inputs, instructions, and references identify a URI. A URI may identify a command for performing by a server or may be included in command information in an HTTP request. In some aspects, command information may include information in one or more headers and/or HTTP entities. For example, a MIME type identifier in an HTTP header may be combined with some or all of a URI to identify a command.

Command information as well as additional data, if any, may be provided to content manager component 412 to generate an HTTP request including the command information, to identify a command for processing by a server. Command information may include an HTTP method token as described above. An HTTP method token may be provided by browser 404 and/or web application agent 406. Content manager component 412 in FIG. 4, operating in user agent node 602, may interoperate with HTTP layer 410 to send the first command information in first HTTP request 802 to server node 604 via network 606. The second command information may analogously be sent in second HTTP request message 806.

An indication to send first HTTP request message 802 and/or second HTTP request message 806 may be received by content manager component 412 from any of various user interface element handler components 416 and/or other components operating in and interoperating with browser 404, such as web application agent 406. Content manager component 412 may format data identifying the first command for inclusion in first HTTP request message 802 and/or the second command for inclusion in second HTTP request message 806. Content manager component 412 may provide the formatted data to request-out component 450 to send first HTTP request message 802 and/or second HTTP request message 806 via HTTP layer 410. HTTP layer 410 may send an HTTP request message to server node 604 via network stack 408 and network 606. The first command and second command are combinable as defined above and described herein.

A combinable first command and a combinable second command may be sent to a server by a user agent in any order. User agent node 602 in FIG. 6 and in FIG. 8 may send second HTTP request message 806 in FIG. 8 to server node 604 before, during, and/or after sending first HTTP request message 802 to server node 604. Analogously, the server node may receive the second command information in the second HTTP request before, during, and/or after receiving the first HTTP request.

In FIG. 2b, block 260 illustrates that the method includes receiving, in a first HTTP request from a user agent node, first command information identifying a first command. Accordingly, a system for processing a combined command response includes means for receiving, in a first HTTP request from a user agent node, first command information identifying a first command. For example, as illustrated in FIG. 3a, the request-in component 360 is configured for receiving, in a first HTTP request from a user agent node, first command information identifying a first command.

Also in FIG. 2b, block 262 illustrates that the method further includes receiving, in a second HTTP request from the user agent node, second command information identifying a second command. Accordingly, a system for processing a combined command response includes means for receiving, in a second HTTP request from the user agent node, second command information identifying a second command. For example, as illustrated in FIG. 3b, the request-in component 360 is configured for receiving, in a second HTTP request from the user agent node, second command information identifying a second command.

FIG. 5 illustrates request-in component 560 as an adaptation of and/or analog of request-out component 360 in FIG. 3b. One or more request-in components 560 operate in execution environment 502. Request-in component 560 in FIG. 5 may receive command information in an HTTP request received in an HTTP request message from user agent node 602 via network stack 508, HTTP layer 510, and/or network application platform 506 as described above. Request-in component 560 may receive some or all information in an HTTP request by interoperating with network application platform 506. Request-in component 560 may identify a command based on the received command information, such as the first command identified by the first command information received in first HTTP request message 802 and the second command identified in the second command information received in second HTTP request message 806. Request-in component 560 may interoperate with one or more components in controller component 512 to identify a command handler component 526 to perform an operation included in processing a command identified in command information included in a received HTTP request.

One or more command handler components 526, illustrated in FIG. 5, may be invoked in response to received command information. For example, first HTTP request 900a may be received in first HTTP request message 802. A metadata command handler component may be invoked based on the first command information. A media streaming command handler component may be invoked based on the second command information in second HTTP request 900b received in second HTTP request message 806. Command information identifying a command may be processed by controller component 512 in identifying a suitable command handler component 526. One or more components of model subsystem 514 may be included in providing information based on command information to one or more command handler components 526 to perform an operation included in processing the command.

Processing of a command, such as the first command, may generate and/or otherwise identify information for generating a command response. For first HTTP request message 802, first information for the first command response may be returned and/or otherwise identified by a first command handler component 526. Second information for generating the second command response may be identified analogously.

A user agent node may send combine-request information to a server node for receiving one or more combined HTTP responses from the server node. Analogously, a server node may receive combine-request information for sending one or more combined HTTP responses to one or more user agent nodes. A server node may receive combine-request information from a user agent node. Alternatively or additionally, a server node may receive combine-request information in response to a user input detected by an input device, based on accessing at least a portion of the combine-request information from a location in a data storage medium, based on receiving a message via a network including and/or identifying at least a portion of the combine-request information, and/or based on identifying a temporal relationship between the first command and the second command.

Combine-request information may be received and/or otherwise accessed by web application 504 to determine whether a command identified in an HTTP request is combinable before invoking a command handler component 526, during processing of an operation included in performing the command by a command handler component 526, and/or after processing of the command by a command handler component 526. In FIG. 5, some or all response generator components 562 may receive combine-request information to determine whether a command response is combinable. Combine-request information may be based on at least one of a specified time, a duration of time, an attribute of the server, an attribute of the user agent, an attribute of an HTTP entity received from the server, and an attribute of a command identified by command information.

In an aspect, combine-request information may identify a combine-request condition for evaluating by a server node and/or a combine-request condition may otherwise be evaluated based on combine-request information. For example, a combine-request condition may identify a temporal condition for evaluating by a server node. First response generator component 562.1 in FIG. 5 may receive combine-request information for processing along with command response information received from one or more command handler components 526 in processing the first command identified in first HTTP request message 802. The combine-request information may identify a duration of time for processing and responding to the command relative to processing and responding to the second command as determined by second response generator component 562.2. If the first command response can be generated within a specified duration of time that the second command response can be generated, a combine-request condition based on the duration identified in the combine-request information is met according to one aspect. In response to determining that the combine-request condition is met, first response generator component 562.1 and/or second response generator 562.2 may determine that the first command response and/or the second command response is combinable.

A combine-request condition may be based on a count identified in combine-request information. In FIG. 4, content manager component 412 may identify a count, such as “2”. The combine-request information may be received in browser 404 configuration, in a web page markup language element, and/or in metadata for a presented media item, to name a few examples. The count may be included in combine-request information sent in an HTTP request by request-out component 450 to web application 504 in FIG. 5. Response generator component 562 may identify combinable commands based on the count. For example, response generator component 562 may determine that command responses to send to the user agent may be combined in pairs in combined HTTP responses as command responses are generated by response generator(s) 562. Alternatively or additionally, combine-request information identifying a count, a duration of time, and the like may be accessed as configuration data for web application 504 instead of or in addition to receiving combine-request information from a user agent node.

A command may be determined to be combinable based on determining that a resource for performing the command is unavailable. A web page presented to a user by presentation controller component 418 in FIG. 4 may indicate that a document is being edited by another user. A UI element handler component 416 may detect a user input for sending an HTTP request including a command for accessing the document and including combine-request information. The combine-request information, when processed by a response generator component 562 in FIG. 5, may indicate that the command response to the user's command is combinable.

As described, an HTTP request may be sent by a user agent node and received by a server node without any explicit indication in the HTTP request that the command identified in the HTTP request may be combined. In FIG. 4, browser 404 may instruct request-out 450 to send first HTTP request 802 without determining whether the command identified in the HTTP request is combinable. Determining whether the command identified in first HTTP request 802 is combinable may be left to server node 604.

Combine-request information may be sent based on configuration information for web application agent 406 in FIG. 4. For example, a script included in web application agent 406 may be configured to include combine-request information to be sent in an HTTP request to web application 504 in FIG. 5 when the script is executed. Alternatively or additionally, a user of browser 404 may configure browser 404 to include combine-request information in some or all HTTP requests according to the user's preferences and browser 404 capabilities. In still another aspect, combine-request information may be received by browser 404 in a message sent by a network and/or systems management application operating in a remote node. In yet another aspect, web application agent 406 may receive an HTTP response indicating that a resource accessed via web application 504 in FIG. 5 is currently unavailable. Web application agent 406 and/or browser 404 may send an HTTP request including combine-request information in response to the indication rather than waiting to retry and/or polling web application 504 until the resource is available. Web application agent 406 may send the HTTP request including the combine-request information automatically in response to receiving the indication from web application 504.

A user agent node may send combine-request information in response to a user input detected by an input device, based on accessing at least a portion of the combine-request information from a location in a data storage medium, based on receiving a message including at least a portion of the combine-request information, and/or based on identifying a temporal relationship between the first command and the second command. Likewise a server node may receive combine-request information in response to a user input detected by an input device, based on accessing at least a portion of the combine-request information from a location in a data storage medium, based on receiving a message including at least a portion of the combine-request information, and based on identifying a temporal relationship between the first command and the second command.

Further, a user agent node may send and a server node may receive combine-request information in an HTTP request included in and/or otherwise based on an HTTP method token, a URI, an HTTP request line, an HTTP general header, an HTTP request header, an HTTP entity, and an HTTP representation.

In FIG. 4, content manager component 412 may instruct request-out component 450 to send combine-request information in an HTTP request to web application 504. The HTTP request may be received by web application 504 and the combine-request information may be received by response generator component 562 via request-in component 560, controller component 512, a command handler component 526, and/or other components included in processing the HTTP request. Some or all of the combine-request information may be included in and/or otherwise identified by a combine header defined to include at least a portion of the combine-request information and included in the HTTP request. FIG. 10a illustrates exemplary combine header 1010a including a correlator.

Combine-request information may be associated with a particular set of HTTP messages in an HTTP communication identified, for example, by a session identifier. Combine-request information may be HTTP request specific, command specific, application specific, user specific, device specific, and/or group specific, to name a few examples. Combine-request information may be sent by user agent node 602 to server node 604 via a protocol other than HTTP. For example, a systems management protocol may be used to exchange configuration options between user agent node 602 and server node 604.

Some or all combine-request information for a command identified in an HTTP request may be included in the HTTP request. Alternatively or additionally, some or all of the combine-request information may be included in another message received prior to sending any of the first command response in an HTTP response.

Combine-request information may identify a MIME type defined to indicate that a command identified in an HTTP request is combinable. A server node may determine that a command identified in an HTTP request is combinable based on the MIME-type identifier. Second HTTP request 900b in FIG. 9b includes multipart/response MIME type identifier 908b. “Multipart/response” may be defined to indicate that a command response to the command identified in first HTTP request 900b sent by a user agent node may be included in a combined HTTP response. In FIG. 4, a text/html content handler component 414 may instruct content manager component 412 to send second HTTP request message 808 in FIG. 8 including multipart/response MIME type identifier 908b in an HTTP ACCEPT header as illustrated in FIG. 9b to indicate that the second command identified in second HTTP request 900b is combinable. In FIG. 5, response generator component 562 interoperating with controller component 512 may detect MIME type identifier 908b and determine that the second command in second HTTP request 900b is combinable.

Combine-request information may identify an HTTP method token defined to indicate that a command response to a command identified in an HTTP request including the HTTP method token is combinable. FIG. 10a illustrates HTTP method token POST-COMBINE 1004a defined to indicate that the command identified by first HTTP request 1000a is combinable. The first command response for the first command identified in first HTTP request 1000a is combinable as indicated at least by HTTP method token POST-COMBINE 1004a. The first command response may be combined with the second command response for second command identified in HTTP request 1000b in FIG. 10b, even if HTTP request 1000b does not include any combine-request information. Note that as illustrated in FIG. 10b does include combine-request information.

Combine-request information may instruct and/or otherwise cause a server to queue and/or cache a command identified in a received HTTP request. A server may queue and/or cache a combinable command until a combine-response condition is met. Response generator component 562 may manage a command queue and/or list. Response generator component 562 may be configured to process a command in a list or queue when resource(s) required for performing the command are available.

Returning to FIG. 2b, block 264 illustrates that the method yet further includes generating a first command response for the first command. Accordingly, a system for processing a combined command response includes means for generating a first command response for the first command. For example, as illustrated in FIG. 3b, first response generator component 362 is configured for generating a first command response for the first command. FIG. 5 illustrates first response generator component 562.1 as an adaptation of and/or analog of first response generator component 362.1 in FIG. 3b.

FIG. 8 illustrates generateResp message 804 communicated within server node 604 for generating a first command response to the first command identified in first HTTP request message 802.

Also in FIG. 2b, block 266 illustrates that the method additionally includes generating a second command response for the second command. Accordingly, a system for processing a combined command response includes means for generating a second command response for the second command. For example, as illustrated in FIG. 3b, a second response generator component 362 is configured for generating a second command response for the second command. FIG. 5 illustrates second response generator component 562.2 as an adaptation of and/or analog of second response generator component 362.2 in FIG. 3b.

FIG. 8 illustrates generateResp message 808 communicated within server node 604 for generating a second command response to the second command identified in second HTTP request message 806.

As described above, controller component 512 and/or a command handler component 526 may provide information from processing a command to a response generator component 562. Response generator components 562 may generate command response information representing a command response to the processed command. A response generator component 562 may invoke template engine component 518 to identify one or more templates and/or other static data to combine with information generated and/or otherwise identified by a command handler component(s) 526 in processing a command.

During processing of a first combinable command and/or a second combinable command by a server, a user agent that sent the combinable commands, to the server, may send, in a third HTTP request, third command information identifying a third command. The server may receive third command information identifying the third command while processing the first command and/or the second command. The server may send a third HTTP response in response to the third HTTP request including a third command response to the third command. The user agent node may receive the third HTTP response. The third command response may be at least partially generated during processing of at least one of the first command and the second command by the server. HTTP request and HTTP response exchanges are currently practiced may be mixed with HTTP communications including combined HTTP responses.

The third HTTP request described in the previous paragraph may include do-not-combine-request information to instruct the server to send the third command response in the third HTTP response. In an aspect, do-not-combine-request information may be detected as lack of any information indicating that the third command is combinable.

A command response generator 562 processing combinable commands may prevent and/or otherwise not send an HTTP response corresponding only to an HTTP request that includes command information identifying the combinable command. In processing the first command received in first HTTP request message 802, first command response generator 562.1 may not send and a first HTTP response corresponding only to the first HTTP request received in first HTTP request message 802. User agent node 602 will not receive the first HTTP response, in this aspect. Second HTTP request message 806 may be processed similarly or a second HTTP response (not shown) for only the second HTTP request may be sent by server node 604 and received by user agent node 602. The second HTTP request, when sent, may not contain the second command response. The second command response is sent in combined HTTP message 814.

Returning to FIG. 2b, block 268 illustrates that the method additionally includes sending a combined HTTP response including the first command response, in response to identifying the first command, and including the second command response, in response to identifying the second command. Accordingly, a system for processing a combined command response includes means for sending a combined HTTP response including the first command response, in response to identifying the first command, and including the second command response, in response to identifying the second command. For example, as illustrated in FIG. 3b, a response-out component 364 is configured for sending a combined HTTP response including the first command response, in response to identifying the first command, and including the second command response, in response to identifying the second command. FIG. 5 illustrates response-out component 564 as an adaptation of and/or analog of response-out component 364 in FIG. 3b. One or more response-out components 564 operate in execution environment 502.

FIG. 8 illustrates combineResp message 812 communicated in server node 604 to an adaptation and/or analog of response-out component 366 for including first command response and second command response in a combined second HTTP response. FIG. 8 illustrates server node 604 sending combined HTTP response message 814 for receiving by user agent node 602 operating as a user agent and/or hosting a user agent.

First response generator component 562.1 and/or second response generator component 562.2 may instruct response-out component 564 to send the first command response and the second command response to browser 404 in combined HTTP response message 814. The first command response may be generated before during and/or after the second command response is generated.

The first command response and the second command response may be received by response-out component 564 in FIG. 5 from first response generator component 562.1 and second response generator component 562.2, respectively. Response-out component 564 may also receive information instructing response-out component 564 to include the first command response and the second command response in a combined HTTP response. The instruction may be provided by one or both of first response generator component 562.1 and second response generator component 562.2.

Response-out component 564 may interoperate with HTTP layer 510 to send a combined command response to browser 404 in user agent node 602 in combined HTTP response message 814. Combined HTTP response 900c and combined HTTP response 1000c illustrate exemplary combined HTTP responses. Some or all of an HTTP response may be generated by response-out component 564. In an aspect, a response-out component 564 may provide command response information to network application platform 506 and/or HTTP layer 510 to include a command response in an HTTP response generated by controller component 512, network application platform 506, and/or HTTP layer 510.

Response-out component 564 may generate and/or otherwise transform at least some of first command response information and/or second command response information into one or more HTTP entities and/or HTTP representations to include in an HTTP response.

Returning to FIG. 2a, block 254 illustrates that the method additionally includes receiving, from the server node, a combined HTTP response. Accordingly, a system for processing a combined command response includes means for receiving, from the server node, a combined HTTP response. For example, as illustrated in FIG. 3a, response-in component 352 is configured for receiving, from the server node, a combined HTTP response. FIG. 4 illustrates response-in component 452 as an adaptation of and/or analog of response-in component 352 in FIG. 3a.

FIG. 8 illustrates isCombined message 816 communicated within user agent node 602 for determining that the combined HTTP response received in combined HTTP response message 814 includes the first command response and the second command response.

Operation of response-in component 452 may operatively couple content manager component 412 to HTTP layer 410 for receiving information in an HTTP response. Some or all of the combined HTTP response receive via combined HTTP response message 814 may be provided to combined response component 454 for determining whether the HTTP response is a combined HTTP response.

Returning to FIG. 2a, block 256 illustrates that the method additionally includes determining, in response to sending the first command information and the second command information, that the combined HTTP response includes a first command response to the first command and a second command response to the second command. Accordingly, a system for processing a combined command response includes means for determining, in response to sending the first command information and the second command information, that the combined HTTP response includes a first command response to the first command and a second command response to the second command. For example, as illustrated in FIG. 3a, combined response component 354 is configured for determining, in response to sending the first command information and the second command information, that the combined HTTP response includes a first command response to the first command and a second command response to the second command. FIG. 4 illustrates combined response component 454 as an adaptation of and/or analog of combined response component 354 in FIG. 3a.

Combined HTTP response 1000c illustrates an exemplary combined HTTP response that may be sent by server node 604 and received by user agent node 602. In FIG. 5, one or more response-out components 564 operating in server node 604 may communicate with one or more command handler components 526 to information for generating the first command response and for generating the second command response information. The first command response is illustrated by first HTTP representation 1014c in first HTTP entity 1016c. The second command response is illustrated by second HTTP representation 1018c included in second HTTP entity 1020c. FIG. 10c illustrates status code 1012c as a status code for the combined HTTP response.

FIG. 9c illustrates exemplary combined HTTP response 900c sent by server node 604 and received by user agent node 602. The first command response is illustrated by first HTTP representation 914c in first HTTP entity 916c. The second command response is illustrated by second HTTP representation 918c included in second HTTP entity 920c. Command responses are included in combined HTTP response 900c in the order that their corresponding commands were sent by browser 404 in user agent node 602.

In an aspect, a first command status code and a second command status code providing status codes for first command response 914c and second command response 918c, respectively, may be provided in addition to combined status code 912c. The first command status code may be provided in an HTTP entity header in first HTTP entity 916c. Response-out component 564 may instruct controller component 512 to send combined HTTP response message 814 as it sends other HTTP responses described above and/or in any other suitable manner.

In FIG. 4, response-in component 452 may receive information transmitted in combined HTTP response message 814 as described above. Response-in component 452 may provide some or all of the information received in combined HTTP message 814 and/or information based on the received combined HTTP response to combined response component 454. Combined response component 454 may determine that the combined HTTP response is a combined HTTP response and may locate the combined command responses including the first command response and second command response.

Combined response component 454 may be included in web application agent 406 and may present a representation of the first command response information and/or otherwise process the information in an application specific manner. This allows browser 404 to operate in a stateless manner with respect to HTTP communication as specified in RFC 2616. Alternatively or additionally, some or all of combined response component 454 may be included in browser 404. Browser 404 may operate in a stateless manner and/or may track state information for combinable commands. In an aspect, browser 404 may maintain an association between a combinable command and a tab, window, and/or other UI element handler component 416 to direct presentation of information based on combined command responses to user interface elements presented by the associated UI element handler component(s) 416.

A server node may send combine-response information to a user agent node for identifying a command response in combined HTTP responses. A user agent node may receive combine-response information from the server node. Combine-response information may be included in and/or otherwise based on an HTTP response line, an HTTP general header, an HTTP response header, an HTTP entity, and/or an HTTP representation.

Combine-response information may indentify a MIME-type defining a combined content type for including a plurality of command responses including the first command response and the second command response. Combined HTTP response 900c in FIG. 9c illustrates multipart/response MIME type identifier 908c identifying a content type defined for including multiple command responses.

In an aspect, a user agent node may detect that a combine-response condition is met based on received combine-response information. The user agent node may determine that a received HTTP response is a combined HTTP response, in response to detecting that the combine-response condition is met. Alternatively or additionally, the user agent node may determine that the combined HTTP response includes at least one of the first command response and the second command response, in response to detecting that the combine-response condition is met. Combined response component 454 in FIG. 4 may evaluate a combine-response condition for matching correlators for the first command and the second command sent in the first HTTP request message 802 and in the second HTTP request message 806, respectively. First HTTP request 1000a illustrates first combine header 1010a identifying a first correlator for identifying the first command response 1014c based on a matching correlator in HTTP entity 1016c in combined HTTP response 1000c. When the correlators match, the combine-response condition is met. In response, combined response component 454 may determine combined HTTP response 900c includes first command response 1014c for the first command identified by first HTTP request 900a. The second command response may be identified analogously.

Combine-response information may identified and/or may be based on a duration of time, an attribute of the server, an attribute of the user agent, an attribute of an HTTP entity sent to the user agent node from the server node, and/or an attribute of a command identified by command information. In an aspect, command responses in combined HTTP response 900c are included in the order in which their corresponding commands were sent by user agent node 602. Combined response component 454 may determine and/or otherwise identify first command response 914c and second command response 918c based on their order in combined HTTP response 900c and the order for sending first HTTP request 900a in FIG. 9a and second HTTP request 900b in FIG. 9b.

In an aspect, combine-response information may include and/or otherwise identify a combine-response matching criterion for determining whether a combine-response condition is met. As described above, a combine-response matching criterion may include an HTTP response correlator identifying a location in an HTTP response for identifying a combined command response and/or may include a symbolic identifier for matching to identify the combined command response. Second HTTP request 1000b in FIG. 10b illustrates a correlator in an optional (indicated by braces) combine cookie 1008b. Response generator component 562 may instruct response-out component 564 to include a corresponding combine-response header and/or combine cookie in combined HTTP response 1000c in FIG. 10c. Combine cookie 1008b may allow combined response component 454 operating in browser 404 and/or web application agent 406 to identify combined HTTP response 1000c and a second command response based on corresponding combine-response information including combine cookie 1022c.

In another aspect, browser 404 may process combined command responses without maintaining any state information. A user agent node may identify and/or create a presentation space in a user interface element and present a user detectable representation generated based on a combined command response in the first presentation space of the UI element. A combined second command response received with the combined first command response may be presented in a same or different presentation space of a same or different UI element. In one aspect, presenting the user detectable representation based on the first command response for the first command may include identifying a second command response, generated by the server node by performing the second command, in a combined HTTP response including the first command response. A user detectable representation may be generated from the first command response and the second command response.

A combined command response may include and/or provide access to data represented according to hypertext markup language (HTML) and/or other markup language, a scripting language, byte code, image data, audio data, and/or machine code.

To the accomplishment of the foregoing and related ends, the descriptions and annexed drawings set forth certain illustrative aspects and implementations of the disclosure. These are indicative of but a few of the various ways in which one or more aspects of the disclosure may be employed. The other aspects, advantages, and novel features of the disclosure will become apparent from the detailed description included herein when considered in conjunction with the annexed drawings.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more instruction-processing units, or by a combination of both. The description herein of any sequence of actions is not intended to imply that the specific order described for performing that sequence must be followed.

Moreover, the methods described herein may be embodied in executable instructions stored in a computer readable medium for use by or in connection with an instruction execution machine, system, apparatus, or device, such as a computer-based or processor-containing machine, system, apparatus, or device. As used here, a “computer readable medium” may include one or more of any suitable media for storing the executable instructions of a computer program in one or more of an electronic, magnetic, optical, electromagnetic, and infrared form, such that the instruction execution machine, system, apparatus, or device may read (or fetch) the instructions from the computer readable medium and execute the instructions for carrying out the described methods. A non-exhaustive list of conventional exemplary computer readable media includes a portable computer diskette; a random access memory (RAM); a read only memory (ROM); an erasable programmable read only memory (EPROM or Flash memory); optical storage devices, including a portable compact disc (CD), a portable digital video disc (DVD), a high definition DVD (HD-DVD™), a Blu-ray™ disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating any non-claimed element is essential to the practice of the subject matter as claimed.

I claim:

1. A method for processing a combined command response, the method comprising:
sending, in a first HTTP request from a user agent node to a server node, first command information identifying a first command;
sending, in a second HTTP request to the server node, second command information identifying a second command;;
receiving, from the server node, a combined HTTP response; and
determining, in response to sending the first command information and the second command information, that the combined HTTP response includes a first command response to the first command and a second command response to the second command.

2. The method of claim 1 wherein at least one of the first command information and the second command information is sent in response to at least one of a detected user input, execution of an instruction received in an HTTP response, and processing of a markup language element received in an HTTP response.

3. The method of claim 1 further comprising sending, to the server node, combine-request information defined to indicate that at least one of the first command response and the second command response are includable in the combined HTTP response.

4. The method of claim 3 wherein the combine-request information is based on at least one of a specified time, a duration of time, an attribute of the server node, an attribute of the user agent node, an attribute of an HTTP entity received from the server node, and an attribute of a command identified by command information.

5. The method of claim 3 wherein the combine-request information identifies at least one of a MIME type and an HTTP method token

6. The method of claim 1 further comprising:
sending, to the server node in a third HTTP request, third command information identifying a third command; and
receiving for the third HTTP request a third HTTP response including for the third command a third command response at least partially generated during processing of at least one of the first command and the second command by the server node.

7. The method of claim 1 further includes receiving combine-response information indicating that at least one of the first command response and the second command response is included in the combined HTTP response.

8. The method of claim 7 wherein the combine-response information identifies a MIME-type defining a combined content type for including a plurality of command responses including the first command response and the second command response.

9. A method for processing a combined command response, the method comprising:
receiving, in a first HTTP request from a user agent node, first command information identifying a first command;
receiving, in a second HTTP request from the user agent node, second command information identifying a second command;
generating a first command response for the first command;
generating a second command response for the second command; and
sending a combined HTTP response including the first command response, in response to identifying the first command, and including the second command response, in response to identifying the second command.

10. The method of claim 10 further comprising receiving combine-request information defined to indicate that at least one of the first command response and the second command response are includable in the combined HTTP response.

11. The method of claim 10 where in the combine-request information identifies at least one of a MIME type and an HTTP method token.

12. The method of claim 10 further comprising sending combine-response information to the user agent node indicating that at least one of the first command response and the second command response is included in the combined HTTP response.

13. The method of claim 12 wherein the combine-response information identifies a MIME-type defining a combined content type for including a plurality of command responses including the first command response and the second command response.

14. A system for processing a combined command response, the system comprising:
an execution environment including an instruction processing unit configured to process an instruction included in at least one of a request-out component, a response-in component, and a combined response component;
the request-out component configured for sending, in a first HTTP request from a user agent node to a server node, first command information identifying a first command;
the request-out component configured for sending, in a second HTTP request to the server node, second command information identifying a second command;
the response-in component configured for receiving, from the server node, a combined HTTP response; and
the combined response component configured for determining, in response to sending the first command information and the second command information, that the combined HTTP response includes a first command response to the first command and a second command response to the second command.

15. A system for processing a combined command response, the system comprising:
an execution environment including an instruction processing unit configured to process an instruction included in at least one of a request-in component, a first response generator component, a second response generator component, and a response-out component;
the request-in component configured for receiving, in a first HTTP request from a user agent node, first command information identifying a first command;
the request-in component configured for receiving, in a second HTTP request from the user agent node, second command information identifying a second command; and
the first response generator component configured for generating a first command response for the first command;
the second response generator component configured for receiving, in a second HTTP request from the user agent node, second command information identifying a second command; and
the response-out component configured for generating a first command response for the first command.

16. A computer readable medium embodying a computer program, executable by a machine, for processing a combined command response, the computer program comprising executable instructions for:
sending, in a first HTTP request from a user agent node to a server node, first command information identifying a first command;
sending, in a second HTTP request to the server node, second command information identifying a second command;
receiving, from the server node, a combined HTTP response; and
determining, in response to sending the first command information and the second command information, that the combined HTTP response includes a first command response to the first command and a second command response to the second command.

17. A computer readable medium embodying a computer program, executable by a machine, for processing a combined command response, the computer program comprising executable instructions for:
receiving, in a first HTTP request from a user agent node, first command information identifying a first command;
receiving, in a second HTTP request from the user agent node, second command information identifying a second command;
generating a first command response for the first command;
generating a second command response for the second command; and
sending a combined HTTP response including the first command response, in response to identifying the first command, and including the second command response, in response to identifying the second command.
